(19) United States
(12) Patent Application Publication
(10) Pub. No.: US 2004/0147423 A1
(43) Pub. Date: Jul. 29, 2004

(54) Dual-compartment laundry composition containing peroxyacids

(75) Inventors: Stefano Scialla, Rome (IT); Connie Lynn Sheets, Cincinnati, OH (US); James Charles Theophile Roger Burckett St. Laurent, Brussels (BE); Marena Dessete Brown, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/679,579

(22) Filed: Oct. 6, 2003

Related U.S. Application Data
(63) Continuation-in-part of application No. 09/980,328, filed on Nov. 30, 2001, now Pat. No. 6,699,828.
Application No. 09/980,328 is a 371 of international application No. PCT/US00/17741, filed on Jun. 27, 2000.
(60) Provisional application No. 60/141,340, filed on Jun. 28, 1999.

(51) Int. Cl. C11D 7/18

(52) U.S. Cl. 510/372

(57) ABSTRACT

Stable aqueous laundry products provided in a first and second part containing a first part comprising a liquid cleaning composition having a pH of from about 4 to about 10 and a second part containing a bleaching composition that contains a peroxyacid. The laundry products also contain a hydrophobic bleach activator and the first and second parts are contained within a package wherein the first part is physically separated from the second part.

### CROSS-REFERENCE TO RELATED APPLICATIONS

This application is a continuation-in-part of prior U.S. application Ser. No. 09/980,328, filed Jun. 27, 2000, claiming benefit of U.S. Provisional application serial No. 60/141,340, filed Jun. 28, 1999.

### FIELD OF INVENTION

The present invention relates to two-part liquid laundry cleaning products wherein the products contain a cleaning part and a bleaching part and provide improved cleaning and whitening performance. The present invention also relates to methods of forming diacyl peroxide in-situ.

### BACKGROUND OF THE INVENTION

Many liquid laundry detergents are currently commercially available to consumers. These laundry detergents all provide cleaning benefits, some of the detergents also propose to provide additional benefits, such as softening of fabrics; brightening of colored clothing; and/or anti-microbial benefits. However, there are very few liquid laundry cleaning products currently commercially available that provide a bleaching system. Incorporation of a bleaching system into a liquid laundry product is often difficult due to the inherent instability associated with bleach in combination with enzymes or other common liquid laundry cleaning ingredients that are sensitive to oxidation.

Despite many years of development there exist at the present time few commercial peracid bleaches which can be stably included into consumer laundry products and used safely, cost-effectively and with acceptable colored goods damage in the cleaning and bleaching of soils from garments. Examples of commercial peracids which may be formulated into stable consumer laundry products include peracetic acid and a limited number of imidoperacids, more particularly including phthalimidoperoxyalkanoic acids, especially phthalimidoperoxyhexanoic acid (PAP), commercially available from Solvay-Interox. PAP is commercially available, but may have shortcomings including a tendency to undergo ring-opening reactions. Peracetic acid is known as a hydrophilic peracid, since it is water-soluble, prefers to partition into the water phase of a water/octanol mixture, and is not amphiphilic. PAP is more hydrophobic (octanol/water) than peracetic acid, though its ring-opening byproduct peracid of formula —OC(O)(C₆H₄)C(O)N(H)(CH₂)₅C(O)OOH and having a negative charge not favorable to interface substantivity, is very hydrophilic. Neither PAP nor its ring-opening byproduct peracid are as amphiphilic as, for example, pernonanoic acid. This may lead to shortcomings, as compared to pernonanoic acid, in that PAP is less able to concentrate at interfaces where soils are located. The shortcomings may include inferior results both on account of lower levels of desired species at the interface and lower effectiveness of more hydrophilic species on hydrophobic soils. However, although pernonanoic acid is typically more useful for bleaching and cleaning, it is not typically commercially available for bulk use as a preformed peracid.

Pernonanoic acid technology has been implemented in laundry detergent products, primarily in the North American markets. Typically, pernonanoic acid is created by providing a hydrophobic bleach activator such as NOBS along with a hydrogen peroxide source in a laundry detergent product such that the pernonanoic acid is formed in-situ within the wash water when the product is used by consumers. This combination generally allows for stable detergents providing bleach benefits to be provided to consumers. Therefore, there is typically no need for a separate bleach ingredient which could make the product less stable. However, this technology is mostly suited for dry, granular laundry detergent products as it was typically difficult to formulate such technology into liquid detergents due to stability problems associated with combining the activator and peroxide source in the same container.

A more recent solution for providing liquid laundry detergent compositions with bleaching benefits is to use a dual-compartment container for separating the reactive ingredients until the time of delivery. Such separation allows for more formulation flexibility. Developments in the area of dual-compartment bottles and containers have furthered the ability to utilize peracids to produce stable and safe consumer laundry detergents. However, with the dual-compartment containers comes additional cost. In order to justify the cost in the sale of the final product, the compositions to be placed in the container also need to be optimized in order to provide additional consumer-recognizable benefits.

Therefore, notwithstanding prior art attempts to solve the bleach instability problem in liquid laundry detergent products, there is a continuing need to identify improved liquid cleaning compositions, bleaches, and combinations thereof that offer improved cleaning and are especially effective for laundering fabrics. There is further a need to identify liquid cleaning compositions wherein the components do not have significant negative interactions with one another during storage.

### SUMMARY OF THE INVENTION

It has now surprisingly been found that a combination of packaging and particular bleach ingredients may be utilized to provide improved cleaning. It has surprisingly been discovered that delivery of the combination of a peroxyacid, hydrophobic bleach activator and a liquid cleaning composition into the wash water provides benefits to which the prior art is unaware.

The present invention relates to stable aqueous laundry products provided in a first and second part comprising:

a) a first part comprising a liquid cleaning composition having a pH of from about 4 to about 10,

b) a second part comprising a bleaching composition, said bleaching composition comprising a peroxyacid.

wherein:

c) the laundry product further comprises a hydrophobic bleach activator; and

d) the first and second parts are contained within a package wherein the first part is physically separated from the second part.

Depending on the location of the hydrophobic bleach activator and/or peroxyacid, the product itself may form diacyl peroxide (DAP) in-situ within the bleaching composition. In addition, the present invention relates to methods of forming diacyl peroxide (DAP) in-situ in the drum of a washing machine or in a washing solution, said methods comprising the steps of:

a) dispensing a laundry product comprising a first part and a second part into the drum of a washing machine or in an appropriate container (e.g., a bucket); and

b) partially filling the drum or the container with water;

wherein the first part comprises a cleaning composition comprising a hydrophobic bleach activator, and mixtures thereof; and the second part comprises a bleaching composition comprising a peroxyacid; and

wherein the first part is physically separated from the second part until dispensed into the drum.

These and other features, aspects, and advantages of the present invention will become evident to those skilled in the art from a reading of the present disclosure.

### DETAILED DESCRIPTION OF THE INVENTION

All documents cited are, in relevant part, incorporated herein by reference; the citation of any document is not to be construed as an admission that it is prior art with respect to the present invention.

While the specification concludes with the claims particularly pointing and distinctly claiming the invention, it is believed that the present invention will be better understood from the following description.

All percentages and ratios used herein are by weight of the total composition and all measurements made are at 25° C., unless otherwise designated.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages, parts and ratios are based upon the total weight of the liquid laundry products of the present invention, unless otherwise specified. All such weights as they pertain to listed ingredients are based on the active level and, therefore, do not include carriers or by-products that may be included in commercially available materials, unless otherwise specified.

Hydrophobic bleach activators such as NOBS have historically been used in conjunction with a hydrogen peroxide source to make pernonanoic acid in-situ without the requirement for a preformed peracid, and preformed peracids such as PAP have historically been used without requirement for another bleach. However, it has now been surprisingly found that the delivery of a liquid laundry product containing a peroxyacid and a hydrophobic bleach activator to the laundry wash water provides improved cleaning capability. In addition, without being limited by theory, it is believed that by physically separating two parts of such a liquid laundry product until the time (or near the time) of use, the product formulator is provided with an opportunity to provide cleaning and fabric care advantages not possible within a single-compartmentalized product. The combination of the peroxyacid and hydrophobic bleach activator with the two-part formulation flexibility provides cleaning benefits to which the present inventors were heretofore unaware.

Further, still without being bound by theory, it is believed that the stain removal benefits deriving from the combination of the various elements of the present invention, are due to the following reaction between the peroxyacid and the hydrophobic bleach activator:

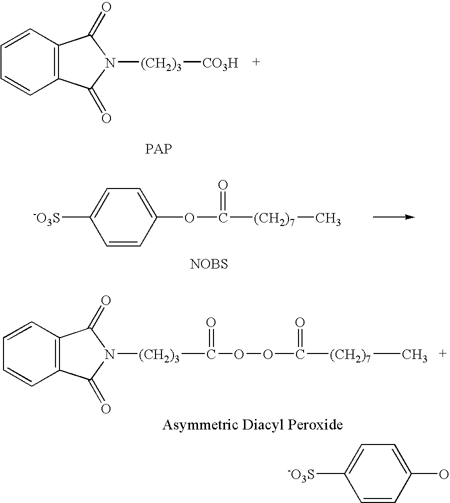

The formation of the asymmetric diacyl peroxide may occur upon mixing of the two parts of the laundry product at the time of use (e.g. in a dosing device and/or in the washing liquor), if the peroxyacid and the hydrophobic bleach activator are comprised in different parts of the laundry product. Alternatively, if the peroxyacid and the hydrophobic bleach activator are both comprised in the bleaching composition, the formation of the diacyl peroxide may partly or completely occur already in the product during storage.

The liquid laundry products of the present invention are provided in a first and second part comprising:

a) a first part comprising a liquid cleaning composition having a pH of from about 4 to about 10,

b) a second part comprising a bleaching composition, said bleaching composition comprising a peroxyacid.

wherein:

c) the laundry product further comprises a hydrophobic bleach activator; and

d) the first and second parts are contained within a package wherein the first part is physically separated from the second part.

The liquid laundry products, cleaning compositions, and bleaching compositions herein may also include a wide variety of other ingredients. The liquid laundry products of the present invention, are described in detail hereinafter.

Laundry Product

As used herein, “liquid laundry products” include hand and machine laundry cleaning compositions including laundry detergents, laundry additive compositions and compositions suitable for use in the soaking and/or pretreatment of stained fabrics.

The liquid laundry products of the present invention are provided in at least two parts, a first part cleaning composition and a second part bleaching composition. The two parts are contained within a package and are physically separated. Examples of physical separation include dual compartment containers, such as dual-compartment bottles like that described in U.S. Pat. No. 4,678,103 to Dirksing. In such bottles, one part of the composition is in one compartment and the other part of the composition is in the other compartment. The two parts preferably do not mix until cleaning performance is desired, such as when the aqueous liquid detergent composition is being poured into a dosing device and/or washing machine.

Preferred packages for use herein are dual-compartment containers. Examples of dual-compartment containers useful herein include the commercially available container used for the “Dobbelman Duo,”™ liquid laundry detergent product distributed in Holland by Sara Lee™ that is the subject of Netherlands Patent No. NL 1018746C to Sara Lee published Sep. 16, 2002. This “Dobbelman Duo”™ two part laundry product is contained within a container formed from two separate plastic containers glued together and the compositions are dispensed by top pouring from two separate openings. Other examples of preferred dual-compartment containers are those found in U.S. Patent Application Publication No. U.S. 2002/0030063 Al to Procter and Gamble, published Mar. 14, 2002. However it is also envisaged that the container may comprise more than two compartments, with the caveat that this may add to the overall container cost.

The packages of the present invention may be substantially rigid, flexible or collapsible and may be made from plastic, glass, metal or metal alloy or combinations thereof. Preferably the container, including all elements of the container, is made from plastic, more preferably thermoplastic material. Examples of preferred thermoplastic materials include polypropylene (PP), polyethylene (PE), polyethylene terephthalate (PET) or combinations thereof.

Packages of the present invention are intended for containing multiple, variable, doses of the same compositions. Therefore, so-called “unit-dose” packages which are known for providing a single dose of liquid laundry detergent are typically unsuitable as packages according to the present invention, even if they are constructed with more than one compartment.

Preferably, the package of the present invention is selected from the group consisting of dual-compartment bottles, dual-compartment bags, dual compartment boxes, and combinations thereof. More preferably, the package of the present invention is a dual-compartment bottle.

The packages of the present invention may have a means for dispensing. As used herein, “means for dispensing” may include simple orifices; more complex pouring orifices (such as those shaped or constructed to provide a steady flow rate); dispensers; pumps, tubes, or combinations thereof.

Preferably the means for dispensing includes a dispenser. As used herein, “dispenser” refers to any system of withdrawing, removing, or channeling the liquid formulations of the present invention from the container either directly to a washing basin/machine drum or to a measuring cup or other means of introducing the compositions into the laundry process. Preferred dispensers herein include those that are gravity fed. Preferred gravity-fed dispensers include press-tap dispensers, i.e., those that are triggered by the press of a button or tab or other means.

Preferably the compartments of the container are designed such that the user can dispense a constant ratio of product from the first compartment and the second compartment throughout use. Methodology for calculating flow ratios, volume dispensed, container manufacture parameters, etc. may be found in U.S. Patent Application Publication No. U.S. 2002/0030063 A1, disclosed above.

Preferably, the laundry products according to the present invention are characterized by a delivered (once dispensed) ratio between the first part (cleaning composition) and the second part (bleaching composition) that ranges from about 10:90 to about 90:10, preferably from about 20:80 to about 80:20, more preferably from about 30:70 to about 70:30, even more preferably from about 40:60 to about 60:40. Therefore, the dispensing means is preferably, capable of dispensing such a first part (cleaning composition) to second part (bleaching composition) ratio. The dispensing means may even be a pour-top container with a dispensing ratio of about 50:50. It will be understood by one of ordinary skill that it is possible to formulate each partial composition to interact with the dispensing ratio in order to deliver a particular combination of ingredients to the dispensed formulation.

Cleaning Composition

The liquid laundry products of the present invention include a first part containing a cleaning composition. The liquid cleaning compositions according to the present invention have a pH of from about 4 to about 10, preferably from about 6 to about 9. The cleaning compositions according to the present invention are preferably liquid detergent compositions.

“Liquid cleaning compositions” as used herein include heavy duty liquid laundry detergent compositions, light duty liquid laundry detergent compositions, liquid fabric softeners, liquid fabric conditioners, laundry pretreators, products for pre-soaking laundry, laundry additives and combinations thereof. Preferably, the liquid cleaning compositions herein are heavy duty aqueous liquid laundry detergent compositions.

Preferably, the liquid cleaning compositions of the present invention useful herein comprise:

(a) at least one element selected from surfactants or hydrophobic bleach activators (see examples hereinafter); and

(b) optionally, but preferably, one or more cleaning adjunct materials.

The liquid cleaning compositions useful herein preferably comprise from about 3% to about 98%, preferably from about 15% to about 95%, by weight of the liquid cleaning composition, of an aqueous liquid carrier which is preferably water.

The density of the laundry cleaning compositions herein preferably ranges from about 400 to about 1200 g/litre, more preferably from about 500 to about 1100 g/litre of composition measured at 20° C.

Surfactants

The liquid cleaning compositions of the present invention preferably comprise a detersive surfactant system which is a single surfactant or a mixture of two or more surfactants and/or co-surfactants. Preferably one or more surfactants are included in the cleaning composition, but it is possible to alternatively or additionally include surfactants in the bleaching composition. The surfactants useful herein include anionic surfactants, nonionic surfactants, amine oxide surfactants, ampholytic surfactants, polyhydroxy fatty acid amide surfactants, cationic surfactants, zwitterionic surfactants, diamine surfactants, and mixtures thereof. Surfactants useful herein include examples of which are given in “Surface Active Agents and Detergents” (Vol. I and II by Schwartz, Perry and Berch). Surfactants useful herein include those discussed more fully in PCT Published Application No. WO 01/00765, published Jan. 4, 2001. A variety of such surfactants are also generally disclosed in U.S. Pat. No. 3,929,678, issued Dec. 30, 1975 to Laughlin, et al and in U.S. Pat. No. 4,285,841, Barrat et al, issued Aug. 25, 1981. Preferably, the surfactant system contains a combination of one or more anionic surfactants and one or more nonionic surfactants.

The liquid cleaning composition preferably comprises at least 0.2% surfactant, more preferably from about 5% to about 70%, more preferably from about 15% to about 30%, by weight of the cleaning composition, of the surfactant system. Any types and classes of surfactants, which are well-known in the art, may be used herein. A description of preferred anionic and nonionic surfactants is provided below.

i. Anionic Surfactant

Anionic surfactants are preferred for use herein. Preferred anionic surfactants include C₁₁-C₁₈ alkyl benzene sulfonates (LAS) and primary, branched-chain and random C₁₀-C₂₀ alkyl sulfates (AS), the C₁₀-C₁₈ secondary (2,3) alkyl sulfates of the formula CH₃(CH₂)ₓ(CHOSO₃⁻M⁺)CH₃ and CH₃ (CH₂)_{y}(CHOSO₃⁻M⁺)CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alkyl alkoxy sulfates (“AExS”; especially EO 1-7 ethoxy sulfates), C₁₀-C₁₈ alkyl alkoxy carboxylates (especially the EO 1-5 ethoxycarboxylates), the C₁₀₋₁₈ glycerol ethers, the C₁₀-C₁₈ alkyl polyglycosides and their corresponding sulfated polyglycosides, and C₁₂-C₁₈ alpha-sulfonated fatty acid esters.

Particularly preferred anionic surfactants herein are the alkyl sulfates. Under cold water washing conditions, i.e., less than about 18.3° C., it is preferred that there be a mixture of ethoxylated and non-ethoxylated alkyl sulfates.

ii. Nonionic Surfactant

The surfactants useful herein include nonionic detergent surfactants. Useful nonionic surfactants include: C₈-C₁₈ alkyl ethoxylates (“AE”), with EO about 1-22, including the so-called narrow peaked alkyl ethoxylates and C₆-C₁₂ alkyl phenol alkoxylates (especially ethoxylates and mixed ethoxy/propoxy), alkyl dialkyl amine oxide, alkanoyl glucose amide, and mixtures thereof.

Preferred are the ethoxylated alcohols and ethoxylated alkyl phenols. Particularly preferred are ethoxylated alcohols having an average of from about 10 to about 15 carbon atoms in the alcohol and an average degree of ethoxylation of from about 6 to about 12 moles of ethylene oxide per mole of alcohol.

Other nonionic surfactants for use herein include, but are not limited to: the polyethylene, polypropylene, and polybutylene oxide condensates of alkyl phenols; alkyl ethoxylates; the condensation products of ethylene oxide with a hydrophobic base formed by the condensation of propylene oxide with propylene glycol; the condensation products of ethylene oxide with the product resulting from the reaction of propylene oxide and ethylenediamine; semi-polar nonionic detergent surfactants; and alkylpolysaccharide surfactants. A preferred alkyleneoxide for use herein is ethylene oxide. Preferred alkylpolyglycosides for use herein include fatty acid amide surfactants.

Cleaning Adjunct Materials

The liquid laundry products of the present invention preferably comprise at least one cleaning adjunct material. The liquid laundry products may include from about 1% to about 99.9% by weight of the composition of one or more cleaning adjunct materials. The term “cleaning adjunct materials”, as used herein, includes any liquid, solid or gaseous material able to contribute to any aspect of the performance and/or aesthetics of the liquid laundry products according to the invention, preferably compatible with the other ingredients present in the compositions of the present invention. Suitable cleaning adjunct materials are more fully discussed in PCT Published Application No. WO 01/00765, published Jan. 4, 2001.

The specific selection of cleaning adjunct materials is readily made by considering the surface, item or fabric to be cleaned. Examples of suitable cleaning adjunct materials include, builders, bleaching agents, bleach catalysts, enzymes, enzyme stabilizing systems, chelants, optical brighteners, soil release polymers, dye transfer agents, dispersants, suds suppressors, dyes, perfumes, colorants, filler salts, hydrotropes, photoactivators, fluorescers, fabric conditioners, fabric softening agents, hydrolyzable surfactants, preservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments and pH control agents. Non-limiting examples of materials belonging to some of these classes are listed below.

i) Suspending Agents

The liquid laundry products of the present invention may preferably comprise, preferably as components of the cleaning composition, a suspending agent. A suspending agent is an ingredient that is specifically added to the composition of the present invention to suspend a solid particulate ingredient of the composition.

Suitable suspending agents are those known in the art. Examples of suspending agents include gum-type polymers, polyvinyl alcohol and derivatives thereof, cellulose and derivatives thereof and polycarboxylate polymers including, but not limited to: tamarind gum, guar gum, locust bean gum, and other industrial gums and polymers, which include, but are not limited to, gellan, welan, rhamsan, dextran, curdlan, hydroxyalkyl cellulose, galactan, pectic galactan, galactomannan, glucomannan, lichenan, mannan, acacia gum, agar, alginates, carrageenan, chitosan, clavan, hyaluronic acid, cellodextrins, carboxymethylcellulose (CMC), dextrans, dextrins, ethylhydroxyethylcellulose (EHEC), guar, hydroxyethylcellulose (HEC), hydroxypropylcellulose (HPC), hydroxybutylcellulose (HBC), methylcellulose (MC), tamarind, xanthan, carboxymethylhydroxyethylcellulose (CMHEC), methoxypropyl methyl cellulose (MPMC), hexylcarboxymethyl cellulose, C₁₂-C₂₀ alkyl carboxymethylcellulose, methylhydroxyethylcellulose (MHEC), methylhydroxypropylcellulose (MHPC), hydroxyethylmethylcellulose (HEMC), hydroxypropylmethylcellulose (HPMC), hydroxybutylmethylcellulose (HBMC) and mixtures thereof.

In a particularly preferred embodiment of the present invention, the suspending agent is selected from a gum-type polymer, preferably a xanthan gum, or a polycarboxylate polymer, preferably a homo or copolymer of monomer units selected from acrylic acid, methacrylic acid, maleic acid, malic acid, maleic anhydride, preferably in a MW range from 1,000,000 to 10,000,000.

The gum-type polymer, when present, is preferably present at a level of from 0.01% to 10%, most preferably from 0.1% to 3%.

The cross-linked polycarboxylate polymer, when present, is preferably present at a level of from 0.01% to 2% more preferably from 0.01% to 1%, most preferably from 0.1% to 0.8%.

In an alternative embodiment the suspending agent comprises a combination of at least two polymers. In this embodiment the first polymer is a gum-type polymer and the second is a cross-linked polycarboxylate polymer. The composition may additionally comprise further polymers.

The ratio of gum-type polymer to cross-linked polycarboxylate polymer is from 100:1 to 1:100, most preferably from 1:10 to 10:1.

ii) Bleach Activators

In addition to the hydrophobic bleach activators described herein, other bleach activators may be present in the liquid laundry products according to the present invention. Examples include tetraacetyl ethylene diamine (TAED), benzoylcaprolactam (BzCL), 4-nitrobenzoylcaprolactam, 3-chlorobenzoylcaprolactam, benzoyloxybenzenesulphonate (BOBS), phenyl benzoate (PhBz), benzoylvalerolactam (BZVL), perhydrolyzable esters and mixtures thereof.

iii) Organic Peroxides, Especially Diacyl Peroxides

Organic peroxides are extensively illustrated in Kirk Othmer, Encyclopedia of Chemical Technology, Vol. 17, John Wiley and Sons, 1982 at pages 27-90 and especially at pages 63-72. If a diacyl peroxide is used, it will preferably be one which exerts minimal adverse impact on spotting/filming.

iv) Metal-Containing Bleach Catalysts

The liquid laundry products herein may include a metal-containing bleach catalyst that is effective for use in bleaching compositions. Suitable examples of metal-containing bleach catalysts are compounds based on Mn, Co, Fe, Ti, W, Mo, Cu, etc., which exert catalytic activity towards peracids, hydrogen peroxide or other organic or inorganic peroxides (and mixtures thereof).

v) Enzymes

The liquid laundry products of the present invention may further comprise one or more enzymes that provide cleaning performance benefits. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases, mannanases, xyloglucanases or mixtures thereof. A preferred combination is a cleaning composition having a cocktail of conventional applicable enzymes like protease, amylase, lipase, cutinase, mannanases, xyloglucanases and/or cellulase. Enzymes when present in the liquid cleaning compositions, at from about 0.0001% to about 5% of active enzyme by weight of the cleaning composition. The enzyme system, when present, should be preferably formulated in the cleaning composition, in order to avoid its interaction with the peracid contained in the bleaching composition.

vi) Enzyme Stabilizers

Enzymes for use in cleaning compositions can be stabilized by various techniques. Enzyme stabilization techniques are disclosed and exemplified in U.S. Pat. No. 3,600,319, EP 199,405 and EP 200,586. Enzyme stabilization systems are also described, for example, in U.S. Pat. No. 3,519,570. A useful Bacillus, sp. AC13 giving proteases, xylanases and cellulases, is described in WO 9401532. The enzymes employed herein can be stabilized by the presence of water-soluble sources of calcium and/or magnesium ions in the finished compositions which provide such ions to the enzymes. Suitable enzyme stabilizers and levels of use are described in U.S. Pat. Nos. 5,705,464, 5,710,115 and 5,576,282.

vii) Chelating Agents

The liquid laundry products of the present invention herein may also optionally contain a chelating agent which serves to chelate metal ions and metal impurities which would otherwise tend to deactivate the bleaching agent(s). Preferably, the chelating agents are comprised at least in the bleaching compositions of the liquid laundry products according to the present invention. Useful chelating agents can include any of those known to those skilled in the art such as amino carboxylates, phosphonates, amino phosphonates, polyfunctionally-substituted aromatic chelating agents and mixtures thereof. Further examples of suitable chelating agents and levels of use are described in U.S. Pat. Nos. 5,705,464, 5,710,115, 5,728,671 and 5,576,282.

The presence of chelating agents contributes to further enhance the chemical stability of the compositions. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704, 233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Typically, the compositions according to the present invention comprise up to about 15%, more preferably up to about 5% by weight of the total composition of a chelating agent, or mixtures thereof, preferably from 0.01% to 1.5% by weight and more preferably from 0.01% to 0.5%.

viii) Radical Scavengers

The liquid laundry products of the present invention may also comprise a radical scavenger or a mixture thereof.

Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl) butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®.

Radical scavengers when used, are typically present herein in amounts up to about 10% by weight of the liquid laundry composition and preferably from about 0.001% to about 0.5% by weight of the liquid laundry composition. They are preferably comprised in the bleaching composition as they can help to improve the storage stability of the peracid component.

ix) Alkoxylated Benzoic Acid

The liquid laundry products according to the present invention may optionally, but preferably comprise an alkoxylated benzoic acid or a salt thereof. Preferably, said alkoxylated benzoic acid or the salt thereof is selected from the group consisting of 3,4,5,-trimethoxy benzoic acid, a salt thereof, 2,3,4-trimethoxy benzoic acid, a salt thereof, 2,4,5-trimethoxy benzoic acid, a salt thereof and a mixture thereof. More preferably, said alkoxylated benzoic acid or the salt thereof is 3,4,5,-trimethoxy benzoic acid. The alkoxylated benzoic acid component should preferable be comprised in the bleaching composition, where it helps the storage stability of the peracid component(s).

x) Polymeric Stabilization System

The laundry product compositions of the present invention may optionally, but preferably comprise a polymeric stabilization system.

The polymeric stabilization system of the present invention comprises polymeric compounds (including oligomeric compounds). “Polymeric compounds” as used herein includes oligomeric compounds and means polymeric and/or oligomeric compounds that are characterized by having both hydrophilic components and hydrophobic components.

The polymeric compounds for use in the compositions of the present invention can include a variety of charged, e.g., anionic or even cationic (see U.S. Pat. No. 4,956,447), as well as noncharged monomer units and the structures may be linear, branched or even star-shaped. They may also include capping moieties which are especially effective in controlling molecular weight or altering the physical or surface-active properties. Structures and charge distributions may be tailored for specific applications for varied cleaning, detergent or detergent additive products.

Many of the suitable polymeric compounds are characterized by having nonionic hydrophile segments or hydrophobe segments which are anionic surfactant-interactive.

Examples of suitable polymeric compounds for use in the compositions of the present invention include, but are not limited to, polymeric compounds having:

(a) one or more nonionic hydrophile components consisting essentially of:

(i) polyoxyethylene segments with a degree of polymerization of at least 2, or

(ii) oxypropylene or polyoxypropylene segments with a degree of polymerization of from 2 to 10, wherein said hydrophile segment does not encompass any oxypropylene unit unless it is bonded to adjacent moieties at each end by ether linkages, or

(iii) a mixture of oxyalkylene units comprising oxyethylene and from 1 to about 30 oxypropylene units; or

(b) one or more hydrophobe components comprising:

(i) C₃ oxyalkylene terephthalate segments, wherein, if said hydrophobe components also comprise oxyethylene terephthalate, the ratio of oxyethylene terephthalate:C₃ oxyalkylene terephthalate units is about 2:1 or lower, and/or

(ii) C₄-C₆ alkylene or oxy C₄-C₆ alkylene segments, or mixtures thereof, and/or

(iii) poly (vinyl ester) segments, preferably poly(vinyl acetate), having a degree of polymerization of at least 2, and/or

(iv) C₁-C₄ alkyl ether or C₄ hydroxyalkyl ether substituents, or mixtures thereof, wherein said substituents are present in the form of C₁-C₄ alkyl ether or C₄ hydroxyalkyl ether cellulose derivatives, or mixtures thereof, and such cellulose derivatives are amphiphilic; or

(c) a combination of (a) and (b).

Typically, the polyoxyethylene segments of (a)(i) will have a degree of polymerization of from 2 to about 200, although higher levels can be used, preferably from 3 to about 150, more preferably from 6 to about 100. Suitable oxy C₄-C₆ alkylene hydrophobe segments include, but are not limited to, end-caps of polymeric compounds such as MO₃S(CH₂)ₙOCH₂CH₂O—, where M is sodium and n is an integer from 4-6, as disclosed in U.S. Pat. No. 4,721,580, issued Jan. 26, 1988 to Gosselink.

Other polymeric compounds useful in the compositions of the present invention include, but are not limited to, cellulosic derivatives such as hydroxyether cellulosic polymers (commercially available from Dow as METHOCEL®); copolymeric blocks of ethylene terephthalate or propylene terephthalate with polyethylene oxide or polypropylene oxide terephthalate examples of which are described in U.S. Pat. Nos. 3,959,230 to Hays, 3,893,929 to Basadur; C₁-C₄ alkylcelluloses and C₄ hydroxyalkyl celluloses such as methylcellulose, Examples of a variety of cellulosic polymeric compounds are described in U.S. Pat. No. 4,000,093 to Nicol, et al.

Other suitable polymeric compounds include the ethyl- or methyl-capped 1,2-propylene terephthalate-polyoxyethylene terephthalate polyesters of U.S. Pat. No. 4,711,730, issued Dec. 8, 1987 to Gosselink et al., the anionic end-capped oligomeric esters of U.S. Pat. No. 4,721,580, issued Jan. 26, 1988 to Gosselink, wherein the anionic end-caps comprise sulfo-polyethoxy groups derived from polyethylene glycol (PEG), the block polyester oligomeric compounds of U.S. Pat. No. 4,702,857, issued Oct. 27, 1987 to Gosselink, having polyethoxy end-caps of the formula X—(OCH₂CH₂)ₙ—wherein n is from 12 to about 43 and X is a C₁-C₄ alkyl, or preferably methyl.

Still yet another class of polymeric compounds for use in the compositions of the present invention include nonionic surfactants having a high degree of ethoxylation, preferably from about 9 to 30 moles of ethyleneoxy units. If nonionic surfactants are used as the polymeric compounds in accordance with the present invention, then preferably the nonionic surfactants are present in the compositions of the present invention at a level of less than 1% by weight of the composition.

One class of preferred polymeric compounds includes, but are not limited to, oligomeric terephthalate esters, typically prepared by processes involving at least one transesterification/oligomerization, often with a metal catalyst such as a titanium(IV) alkoxide. Such esters may be made using additional monomers capable of being incorporated into the ester structure through one, two, three, four or more positions, without of course forming a densely crosslinked overall structure.

Another type of preferred polymeric compound is a copolymer having random blocks of ethylene terephthalate and polyethylene oxide (PEO) terephthalate. More specifically, these polymers are comprised of repeating units of ethylene terephthalate and PEO terephthalate in a preferred mole ratio of ethylene terephthalate units to PEO terephthalate units of from about 25:75 to about 35:65, said PEO terephthalate units containing polyethylene oxide having molecular weights of from about 300 to about 2,000. The molecular weight of this polymeric compound is preferably in the range of from about 25,000 to about 55,000. See U.S. Pat. No. 3,959,230 to Hays, U.S. Pat. No. 3,893,929 to Basadur for examples of such polymeric compounds.

Still another preferred polymeric compound is a polyester with repeating units of ethylene terephthalate units containing from about 10-15% by weight of ethylene terephthalate units together with about 90-80% by weight of polyoxyethylene terephthalate units, derived from a polyoxyethylene glycol of average molecular weight of about 300 to about 5,000, and the mole ratio of ethylene terephthalate units to polyoxyethylene terephthalate units in the polymeric compound is preferably between about 2:1 to about 6:1. Examples of this type of polymeric compound include the commercially available material ZELCON® from DuPont and MILEASE® T from ICI. These polymeric compounds and methods of their preparation are more fully described in U.S. Pat. No. 4,702,857 to Gosselink.

Another class of preferred polymeric compounds includes, but is not limited to, sulfonated products of substantially linear ester oligomers comprised of an oligomeric ester backbone of terephthaloyl and oxyalkyleneoxy repeat units and allyl-derived sulfonated terminal moieties covalently attached to the backbone, for example as described in U.S. Pat. No. 4,968,451, Nov. 6, 1990 to J. J. Scheibel and E. P. Gosselink: such ester oligomers can be prepared by (a) ethoxylating allyl alcohol, (b) reacting the product of (a) with dimethyl terephthalate (“DMT”) and 1,2-propylene glycol (“PG”) in a two-stage transesterification/oligomerization procedure and (c) reacting the product of (b) with sodium metabisulfite in water; the nonionic end-capped 1,2-propylene/polyoxyethylene terephthalate polyesters of U.S. Pat. No. 4,711,730, Dec. 8, 1987 to Gosselink et al, for example those produced by transesterification/oligomerization of poly(ethyleneglycol) methyl ether, DMT, PG and poly(ethyleneglycol) (“PEG”); the partly- and fully-anionic-end-capped oligomeric esters of U.S. Pat. No. 4,721,580, Jan. 26, 1988 to Gosselink, such as oligomers from ethylene glycol (“EG”), PG, DMT and Na-3,6-dioxa-8-hydroxyoctanesulfonate; the nonionic-capped block polyester oligomeric compounds of U.S. Pat. No. 4,702,857, Oct. 27, 1987 to Gosselink, for example produced from DMT, Me-capped PEG and EG and/or PG, or a combination of DMT, EG and/or PG, Me-capped PEG and Na-dimethyl-5-sulfoisophthalate; and the anionic, especially sulfoaroyl, end-capped terephthalate esters of U.S. Pat. No. 4,877,896, Oct. 31, 1989 to Maldonado, Gosselink et al, the latter being typical of polymeric compounds useful in both laundry and fabric conditioning products, an example being an ester composition made from m-sulfobenzoic acid monosodium salt, PG and DMT optionally but preferably further comprising added PEG, e.g., PEG 3400.

Another preferred polymeric compound is an oligomer having empirical formula (CAP)₂(EG/PG)₅(T)₅(SIP)₁ which comprises terephthaloyl (T), sulfoisophthaloyl (SIP), oxyethyleneoxy and oxy-1,2-propylene (EG/PG) units and which is preferably terminated with end-caps (CAP), preferably modified isethionates, as in an oligomer comprising one sulfoisophthaloyl unit, 5 terephthaloyl units, oxyethyleneoxy and oxy-1,2-propyleneoxy units in a defined ratio, preferably about 0.5:1 to about 10:1, and two end-cap units derived from sodium 2-(2-hydroxyethoxy)-ethanesulfonate. Said polymeric compound preferably further comprises from 0.5% to 20%, by weight of the oligomer, of a crystallinity-reducing stabilizer, for example an anionic surfactant such as linear sodium dodecylbenzenesulfonate or a member selected from xylene-, cumene-, and toluene-sulfonates or mixtures thereof, these stabilizers or modifiers being introduced into the synthesis pot, all as taught in U.S. Pat. No. 5,415,807, Gosselink, Pan, Kellett and Hall, issued May 16, 1995. Suitable monomers for the above polymeric compound include Na 2-(2-hydroxyethoxy)-ethanesulfonate, DMT, Na-dimethyl 5-sulfoisophthalate, EG and PG.

Yet another group of preferred polymeric compounds are oligomeric esters comprising: (1) a backbone comprising (a) at least one unit selected from the group consisting of dihydroxysulfonates, polyhydroxy sulfonates, a unit which is at least trifunctional whereby ester linkages are formed resulting in a branched oligomer backbone, and combinations thereof; (b) at least one unit which is a terephthaloyl moiety; and (c) at least one unsulfonated unit which is a 1,2-oxyalkyleneoxy moiety; and (2) one or more capping units selected from nonionic capping units, anionic capping units such as alkoxylated, preferably ethoxylated, isethionates, alkoxylated propanesulfonates, alkoxylated propanedisulfonates, alkoxylated phenolsulfonates, sulfoaroyl derivatives and mixtures thereof. Preferred of such esters are those of empirical formula:

{(CAP)x(EG/PG)y′(DEG)y″(PEG)y′″(T)z(SIP)z′(SEG)q(B)m}

wherein CAP, EG/PG, PEG, T and SIP are as defined hereinabove, (DEG) represents di(oxyethylene)oxy units; (SEG) represents units derived from the sulfoethyl ether of glycerin and related moiety units; (B) represents branching units which are at least trifunctional whereby ester linkages are formed resulting in a branched oligomer backbone; x is from about 1 to about 12; y′ is from about 0.5 to about 25; y″ is from 0 to about 12; y′″ is from 0 to about 10; y′+y″+y′″ totals from about 0.5 to about 25; z is from about 1.5 to about 25; z′ is from 0 to about 12; z+z′ totals from about 1.5 to about 25; q is from about 0.05 to about 12; m is from about 0.01 to about 10; and x, y′, y″, y′″, z, z′, q and m represent the average number of moles of the corresponding units per mole of said ester and said ester has a molecular weight ranging from about 500 to about 5,000.

Preferred SEG and CAP monomers for the above esters include Na-2-(2-,3-dihydroxypropoxy)ethanesulfonate (“SEG”), Na-2-{2-(2-hydroxyethoxy) ethoxy}ethanesulfonate (“SE3”) and its homologues and mixtures thereof and the products of ethoxylating and sulfonating allyl alcohol. Preferred polymeric compound esters in this class include the product of transesterifying and oligomerizing sodium 2-{2-(2-hydroxyethoxy)ethoxy}ethanesulfonate and/or sodium 2-[2-{2-(2-hydroxyethoxy)-ethoxy}ethoxy]ethanesulfonate, DMT, sodium 2-(2,3-dihydroxypropoxy) ethane sulfonate, EG, and PG using an appropriate Ti(IV) catalyst and can be designated as (CAP)2(T)5(EG/PG)1.4(SEG)2.5(B)0.13 wherein CAP is (Na^{+-O}₃S[CH₂CH₂O]3.5)- and B is a unit from glycerin and the mole ratio EG/PG is about 1.7:1 as measured by conventional gas chromatography after complete hydrolysis.

Still yet another preferred class of polymeric compounds for use in the compositions of the present invention include oligomeric, substantially linear, sulfonated poly-ethoxy/propoxy end-capped esters, examples of which and methods of preparation are described in U.S. Pat. No. 5,415,807 to Gosselink et al. The esters comprise oxyethyleneoxy units and terephthaloyl units. Preferred esters additionally comprise units of oxy-1,2-propyleneoxy, sulfoisophthalate and, optionally, poly(oxyethylene)oxy units (with degee of polymerization from 2 to 4). The esters are of relatively low molecular weight, typically ranging from about 500 to about 8,000. Taken in their broadest aspect, the polymeric compounds of this class encompass an oligomeric ester “backbone” which is end-capped on one, or preferably both, ends of the backbone by the essential end-capping units.

The essential end-capping units are anionic hydrophiles derived from sulfonated poly-ethoxy/propoxy groups and connected to the esters by an ester linkage. The preferred end-capping units are of the formula (MO₃S)(CH₂)ₘ(CH₂CH₂O)(RO)ₙ—wherein N is a salt-forming cation such as sodium or tetraalkylammonium, m is 0 or 1, R is ethylene, propylene, or a mixture thereof, and n is from 0 to 2; and mixtures thereof.

Certain noncharged, hydrophobic aryldicarbonyl units are essential in the backbone unit of the oligoesters herein. Preferably, these are exclusively terephthaloyl units.

Preferred esters of this class comprise, per mole of said ester:

i) from about 1 to about 2 moles of sulfonated poly-ethoxy/propoxy end-capping units of the formula (MO₃S)(CH₂)ₘ(CH₂CH₂O)(RO)ₙ—wherein H is a salt-forming cation such as sodium or tetraalkylammonium, m is 0 or 1, R is ethylene, propylene or a mixture thereof, and n is from 0 to 2; and mixtures thereof;

ii) from about 0.5 to about 66 moles of units selected from the group consisting of:

a) oxyethyleneoxy units;

b) a mixture of oxyethyleneoxy and oxy-1,2-propyleneoxy units wherein said oxyethyleneoxy units are present in an oxyethyleneoxy to oxy-1,2-propyleneoxy mole ratio ranging from 0.5:1 to about 10:1; and

c) a mixture of a) or b) with poly(oxyethylene)oxy units wherein said poly(oxyethylene)oxy units have a degree of polymerization of from 2 to 4; provided that when said poly(oxyethylene)oxy units have a degree of polymerization of 2, the mole ratio of poly(oxyethylene)oxy units to total group ii) units ranges from 0:1 to about 0.33:1; and when said poly(oxyethylene)oxy units have a degree of polymerization of 3, the mole ratio of poly(oxyethylene)oxy units to total group ii) units ranges from 0:1 to about 0.22:1; and when said poly(oxyethylene)oxy units have a degree of polymerization of 4, the mole ratio of poly(oxyethylene)oxy units to total group ii) units ranges from 0:1 to about 0.14:1; iii) from about 1.5 to about 40 moles of terephthaloyl units; and iv) from 0 to about 26 moles of 5-sulfoisophthaloyl units of the formula —(O)C(C₆H₃)(SO₃M)C(O)— wherein M is a salt forming cation such as an alkali metal or tetraalkylammonium ion.

More preferably, the polymeric compounds for use in the compositions of the present invention are selected from the group of polymeric compounds described in U.S. Pat. No. 4,702,857 to Gosselink, U.S. Pat. No. 4,968,451 to Scheibel et al., U.S. Pat. No. 5,415,807 to Gosselink et al. and mixtures thereof.

Most preferably, the polymeric compounds for use in the compositions of the present invention are the polymeric compounds described in U.S. Pat. No. 4,968,451 to Scheibel et al.

In addition to providing stabilization of the compositions of the present invention, as described herein, the polymeric stabilization system also provides the compositions with acceptable eye irritation profiles. In other words, the presence of the polymeric stabilization system within the compositions of the present invention results in lower eye irritation properties as compared to compositions lacking the polymeric stabilization system as measured using the Chicken Ex Vivo Eye Test, which can be conducted by the TNO Nutrition and Food Research Institute in The Netherlands. The preferred polymeric stabilization system for this purpose comprises the polymeric compounds described in U.S. Pat. No. 4,968,451 to Scheibel et al.

When present, the compositions of the present invention will generally comprise from about 0.01% to about 10%, by weight of the composition, of the polymeric compounds, typically from about 0.1% to about 5%, preferably from about 0.02% to about 3.0%.

The compositions according to the present invention can be in a “concentrated form”, in such case, the compositions according to the present invention will contain a lower amount of water, compared to conventional compositions. Typically the water content of such a concentrated composition is preferably less than 40%, more preferably less than 30%, most preferably less than 20% by weight of the composition.

Further, the compositions according to the present invention may be isotropic liquids, aqueous gels and/or colored liquid compositions.

Bleaching Composition

The laundry products of the present invention include, as a second part, a bleaching composition. As used herein, “bleaching composition” refers generally to those compositions that may be used during the laundering process to remove or decolorize colored stains or dinginess from clothing/fabric items in the wash. In order to ensure the storage stability of the product, the pH of the bleaching composition should be from about 1 to about 7, preferably from about 2 to about 6, most preferably from about 3 to about 5.

The bleaching compositions of the present invention contain a suspension of a preformed Peroxy Carboxylic acid (hereinafter referred to as a “peroxyacid”). Any suitable peroxyacid compound known in the art may be used herein. The peroxyacid is preferably present in the bleaching composition at a level of from about 0.1% to about 25%, more preferably from about 0.1% to about 20%, even more preferably from about 1% to about 10%, by weight of the bleaching composition. Alternatively, the peroxyacid may be present at a much higher level of for example 10% to 40%, more preferably from 15% to 30%, most preferably from 15% to 25%, by weight of the bleaching composition.

Preferably, the peroxyacid is selected from the group consisting of percarboxylic acids and salts, percarbonic acids and salts, perimidic acids and salts, peroxymonosulfuric acids and salts, and mixtures thereof.

One class of suitable organic peroxycarboxylic acids have the general formula:

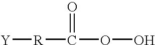

wherein R is an alkylene or substituted alkylene group containing from 1 to about 22 carbon atoms or a phenylene or substituted phenylene group, and Y is hydrogen, halogen, alkyl, aryl, —C(O)OH or —C(O)OOH.

Organic peroxyacids suitable for use in the present invention can contain either one or two peroxy groups and can be either aliphatic or aromatic. When the organic peroxycarboxylic acid is aliphatic, the unsubstituted acid has the general formula:

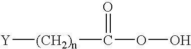

where Y can be, for example, H, CH₃, CH₂Cl, C(O)OH, or C(O)OOH; and n is an integer from 1 to 20. When the organic peroxycarboxylic acid is aromatic, the unsubstituted acid has the general formula:

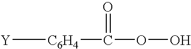

wherein Y can be, for example, hydrogen, alkyl, alkylhalogen, halogen, C(O)OH or C(O)OOH.

Monoperoxy acids useful herein include alkyl and aryl peroxyacids such as: peroxybenzoic acids and ring-substituted peroxybenzoic acids including peroxy-a-naphthoic acid, monoperoxyphthalic acid (magnesium salt hexahydrate), and o-carboxybenzamidoperoxyhexanoic acid (sodium salt); aliphatic, substituted aliphatic and arylalkyl monoperoxy acids, including peroxylauric acid, peroxystearic acid, N-nonanoylaminoperoxycaproic acid (NAPCA), N,N-(3-octylsuccinoyl)aminoperoxycaproic acid (SAPA) and N,N-phthaloylaminoperoxycaproic acid (PAP); and amidoperoxyacids including monononylamide of either peroxysuccinic acid (NAPSA) or of peroxyadipic acid (NAPAA).

Diperoxyacids useful herein include alkyl diperoxyacids and aryldiperoxyacids, such as: 1,12-diperoxydodecanedioic acid; 1,9-diperoxyazelaic acid; diperoxybrassylic acid; diperoxysebacic acid and diperoxyisophthalic acid; 2-decyldiperoxybutane-1,4-dioic acid; and 4,4′-sulfonylbisperoxybenzoic acid. Such bleaching agents are disclosed in U.S. Pat. No. 4,483,781, Hartman, issued Nov. 20, 1984; U.S. Pat. No. 4,634,551 to Burns et al.; European Patent Application 0,133,354 to Banks et al. published Feb. 20, 1985; and U.S. Pat. No. 4,412,934 to Chung et al. issued Nov. 1, 1983. Sources also include 6-nonylamino-6-oxoperoxycaproic acid as described in U.S. Pat. No. 4,634,551, issued Jan. 6, 1987 to Burns et al. Persulfate compounds such as for example OXONE, manufactured commercially by E.I. DuPont de Nemours of Wilmington, Del. can also be employed as a suitable source of peroxymonosulfuric acid.

Particularly preferred peroxyacids are those having the formula:

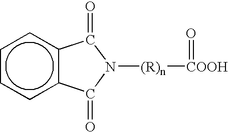

wherein R is C₁₋₄ alkyl and n is an integer of from 1 to 5.

A highly preferred preformed peroxyacid is PAP. As used herein, “PAP” refers to the preformed organic peroxyacid phthalimidoperoxyhexanoic acid (also referred to as phthalimidoperhexanoic acid or phthalimidoperoxycaproic acid) having the formula:

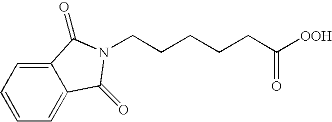

PAP is commercially available from Solvay-Interox™ and formerly from Ausimont SpA™ under the tradename Eureko™. PAP has CAS registry number 128275-31-0 and is available as the compound alone or in commercial forms which include wet-cake and compounded forms.

In a particularly preferred embodiment of the present invention the peroxyacid has mean average particle size of less than 100 microns, more preferably less than 80 microns, even more preferably less than 60 microns. Most preferably, when the peroxyacid is PAP, it has a mean average particle size of between about 20 and about 50 microns.

In addition, the bleaching compositions of the present invention may further comprise any ingredient listed hereinbefore under the section ‘Cleaning Adjunct Materials’ of the Cleaning Compositions according to the present invention, provided that there is no incompatibility between the peroxyacid and the selected ingredient. In particular, enzymes and other ingredients sensitive to oxidizing agents typically should not be formulated in the bleaching compositions according to the present invention, unless a suitable encapsulation method is used to protect them, in order to avoid storage stability problems.

The peracid is preferably in the form of solid particles suspended in the bleaching composition. Therefore, the bleaching composition preferably further comprises a suspending agent for the peracid. Suitable suspending agents have been described herein.

The bleaching compositions of the present invention also preferably comprise an adjunct material selected from the groups of polymeric stabilization systems, chelating agents, radical scavengers, and alkoxylated benzoic acids, to help the physical and chemical stabilization of the peroxyacid(s). All of these ingredients have been described in the corresponding paragraphs hereinbefore.

Hydrogen Peroxide

An additional ingredient that may be present in the bleaching compositions according to the present invention, is hydrogen peroxide and its sources thereof. The source of peroxide is preferably hydrogen peroxide, but may be any suitable source of peroxide and present at any level, such as fully described in U.S. Pat. No. 5,576,282. Preferably, the bleaching compositions comprise from about 0.001% to about 15%, by weight of the bleaching composition, of the peroxide and/or source of peroxide, more preferably from about 0.01% to about 10%, most preferably from about 0.1% to about 6%.

Examples of hydrogen peroxide sources useful herein include perborate compounds, percarbonate compounds, perphosphate compounds, urea-peroxide compounds, and mixtures thereof. Preferred peroxide sources useful herein include sodium perborate (any hydrate but preferably the mono- or tetra-hydrate), sodium carbonate peroxyhydrate or equivalent percarbonate salts, sodium pyrophosphate peroxyhydrate, urea peroxyhydrate, and/or sodium peroxide. Also useful are sources of available oxygen such as persulfate bleach (e.g., OXONE,™ manufactured by DuPont™). Mixtures of any convenient hydrogen peroxide sources can also be used.

Various forms of sodium perborate and sodium percarbonate, such as coated and modified forms may be used.

Hydrogen peroxide and sources thereof may be used, in some embodiments of the present invention, also in the cleaning component, provided that enzymes and other incompatible ingredients are not present.

Hydrophobic Bleach Activator

The laundry products of the present invention further contain a hydrophobic bleach activator. The hydrophobic bleach activator may be included in either the cleaning composition or the bleaching composition, or may even be included in both compositions. Preferably, the compositions herein comprise from about 0.1% to about 10%, by weight of the cleaning composition and/or of the bleaching composition, of the hydrophobic bleach activator, preferably from about 0.2% to about 4%.

Preferably, the cleaning composition comprises NOBS (nonanoyloxybenzenesulfonate), having a structure as follows:

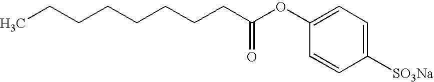

The sulfonic acid form of NOBS has CAS Registry Number 101482-85-3 and may also be referred to as a nonanoic acid sulfophenyl ester. Other preferred hydrophobic bleach activators for use herein include the bleach activators with a homolog structure to NOBS, i.e. those having the general structure

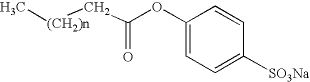

Where n can range from about 2 and to about 13, preferably from about 3 to about 9. Analogs of NOBS such as NOB, LOBS or DOBA are also preferred. Still other hydrophobic bleach activators suitable for use in the laundry products of the present invention include esters of linear or branched, saturated or unsaturated carboxylic acids. For example, suitable activators include carboxylic acid esters with alcohols, glycols (such as ethylene glycol), glycerol (e.g. triacetin, diacetin, tripropyrrin, dipropyrrin, tributyrrin, trihexanoin, trinonanoin, etc.). Preferably, all these activators contain alkanoyloxy moieties:

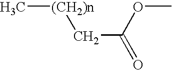

wherein n ranges from about 3 to about 14, preferably from about 4 to about 10.

Preferably, the pH of the composition where the bleach activator is included is between 4 and 9. In addition, it is preferable to avoid or limit the co-presence in the same part of the liquid laundry products according to the present invention, of the hydrophobic bleach activator and of the following ingredients, which may enhance its degradation: hydrogen peroxide and sources thereof; ingredients that provide nucleophilic nitrogen sites (e.g. aminoxides, amines); fatty acids; and borax.

Optional Foaming System

The laundry products of the present invention may further comprise a foaming system, such as those known in the art for providing foamed cleaning compositions. The foaming system may utilize the available hydrogen peroxide if present in the bleaching composition by adding a catalyst to the cleaning composition. Alternatively, the foaming system may be formed by adding an acid to the bleaching composition and a base to the cleaning composition whereupon when the two compositions are mixed at the point of use, foaming reactions occur.

A) Hydrogen-Peroxide Based Systems

In these embodiments the bleaching compositions comprise hydrogen peroxide and/or sources thereof, as described above. In this instance, the cleaning compositions may include an ‘effervescent agent’ which is preferably selected from a peroxide reducing enzyme, such as peroxidase, laccase, dioxygenase and/or catalase enzyme, preferably catalase enzyme. The efferevescent agent is preferably included in the cleaning composition at a level of from about 0.001% to about 10%, more preferably, from about 0.01% to about 5%, most preferably from about 0.1% to about 0.3% by weight of the cleaning composition. Catalase enzymes are commercially available, for instance, from Biozyme Laboratories under the trade name CAT-1A,; from Genencor International under the trade name OXY-GONE 400; and from Novo Nordisk.

B) Acid-Base Systems

In order to provide foaming due to an acid-base reaction, the bleaching compositions herein may include a suitable acid agent, while the cleaning compositions herein include a base agent. When combined upon dispensing, foaming of the composition occurs due to the reaction between the acid and base components.

Suitable acids for use in the bleaching compositions herein result in a pH of the bleaching compositions of about 7 or less, preferably from about 0 to about 6, more preferably from about 3 to about 4. Preferably, the acid is included at a level of from about 1% to about 20%, more preferably from about 3% to about 10% by weight of the bleaching compositions.

Nonlimiting examples of suitable acids for use in the present invention include inorganic acids, organic acids and mixtures thereof. Preferably, the inorganic acids are selected from the group consisting of sulfuric acid, hydrochloric acid, phosphoric acid, nitric acid and mixtures thereof. Preferably, the organic acids are selected from the group consisting of formic acid, acetic acid, C₁₂-C₁₈ fatty acids, malic acid, maleic acid, malonic acid, succinic acid, tartaric acid, lactic acid, glutaric acid, fumaric acid, benzoic acid, phthalic acid, citric acid and mixtures thereof. Organic acids are preferred, most preferred are citric acid and/or succinic acid.

The base that may be included in the cleaning compositions herein are preferably present at a level of from about 1% to about 10%, more preferably from about 2% to about 5% by weight of the cleaning composition.

Suitable bases for use in the cleaning compositions herein include, but are not limited to, carbonates, bicarbonates, sesquicarbonates and mixtures thereof. The most preferred bases are selected from the group consisting of sodium bicarbonate, monoethanolammonium bicarbonate and mixtures thereof.

In addition, foaming systems based on both types of foaming interactions may be included in the laundry cleaning products.

Methods of Laundry

The invention herein also encompasses a method for laundering fabrics wherein the fabrics are placed in the drum of a washing machine along with the laundry product of the present invention or are alternatively hand-washed in conjunction with the laundry product of the present invention. In addition, the invention herein also encompasses a laundering pretreatment process for fabrics which have been soiled or stained comprising directly contacting said stains and/or soils with a highly concentrated form of the laundry composition set forth above prior to washing such fabrics using conventional aqueous washing solutions. Preferably, the laundry composition remains in contact with the soil/stain for a period of from about 30 seconds to 24 hours prior to washing the pretreated soiled/stained substrate in conventional manner. More preferably, pretreatment times will range from about 1 to 180 minutes.

### EXAMPLES

### Examples 1A and 1B

Heavy duty aqueous liquid detergent compositions in accordance with the present invention are prepared and stored in dual-compartment containers as follows (the dual compartment container is designed to deliver preferably a 4:1 weight ratio of the first compartment product vs the second compartment product).

| | 1A | 1B |
|---|---|---|
| | % by weight of | % by weight of |
| | composition in | composition in |
| | compartment | compartment |
| First Compartment | | |
| MEA | 1.10 | — |
| NOBS | — | 1.0 |
| C10 APA | 0.50 | 0.50 |
| Na C25AE1.80S | 19.35 | 19.35 |
| Propylene Glycol or Glycerol | 7.50 | 7.50 |
| Neodol 23-9 | 0.63 | 0.63 |
| FWA-15 | 0.15 | 0.15 |
| Na Toluene Sulfonate | 2.25 | 2.25 |
| NaOH | 2.79 | 3.3 |
| N-Cocoyl N-Methyl Glucamine | 2.50 | 2.50 |
| Citric Acid | 3.00 | 3.00 |
| C12-16 Real Soap | 2.00 | 1.0 |
| Borax | 2.50 | 1.0 |
| EtOH | 3.25 | 3.25 |
| Ca Formate | 0.09 | 0.2 |
| Polyethyleneimine (MW 600) | 1.30 | 0.5 |
| ethoxylated and average of 20 times | | |
| per nitrogen | | |
| Ethoxylated Tetraethylene-Pentaimine | 0.60 | 0.60 |
| Na Formate | 0.115 | 0.115 |
| Fumed Silica | 0.0015 | 0.0015 |
| Soil Release Polymer | 0.08 | 0.08 |
| Blue Liquitint 65 | 0.016 | 0.016 |
| Protease | 1.24 | 1.24 |
| Cellulase | 0.043 | 0.043 |
| Amylase | 0.15 | 0.15 |
| Silicone | 0.119 | 0.119 |
| Neptune LC | 0.35 | 0.35 |
| DTPA | 0.30 | 0.30 |
| Sodium Bicarbonate (Effervescent | 2.00 | — |
| agent) | | |
| Catalase Enzyme (Effervescent agent) | — | 0.15 |
| Water | Balance | Balance |
| Second Compartment | | |
| NaOH | 3.46 | 3.46 |
| PAP | 10.0 | 15.0 |
| NOBS | 2.0 | |
| Citric Acid (Acid agent) | 20.90 | — |
| Hydrogen Peroxide (Source of | — | 4 |
| Peroxide) | | |
| Titanium Dioxide | 2.50 | 2.50 |
| Xanthan Gum | 0.45 | 0.45 |
| Water | Balance | Balance |

### Examples 2A and 2B

Heavy duty aqueous liquid detergent compositions in accordance with the present invention are prepared in dual-compartment containers as follows (the dual compartment container is designed to deliver preferably a 1:1 weight ratio of the first compartment product vs the second compartment product). Composition 2B is suitable for foaming upon mixing.

| | 2A | 2B |
|---|---|---|
| | % by weight of | % by weight of |
| | composition in | composition in |
| | compartment | compartment |
| First Compartment | | |
| C12-15 Alkyl alcohol 5 | 20 | 20 |
| ethoxylated | | |
| LAS | 10 | 10 |
| NOBS | — | 1.0 |
| Sodium bicarbonate | — | 3 |
| Propylene glycol | 5 | 5 |
| Cumene sulfonic acid | 5 | 5 |
| Monoethanolamine | to pH 8.5 | to pH 8.5 |
| Boosters, enzymes, | 5 | 5 |
| perfume | | |
| Water | Balance | Balance |
| Second Compartment | | |
| PAP | 3.0 | 5.0 |
| NOBS | 1.0 | — |
| Citric acid | — | 30 |
| Xanthan Gum | 0.51 | 0.51 |
| Sodium hydroxide | to pH 4.0 | to pH 3.0 |
| Water | Balance | Balance |

The compositions of the present invention can be suitably prepared by any traditional process chosen by the formulator, examples of which are described in PCT Published Application No. WO 01/00765, published Jan. 4, 2001.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A stable aqueous laundry product provided in a first and second part comprising:
a) a first part comprising a liquid cleaning composition having a pH of from about 4 to about 10,
b) a second part comprising a bleaching composition, said bleaching composition comprising a peroxyacid.
wherein:
c) the laundry product further comprises a hydrophobic bleach activator; and
d) the first and second parts are contained within a package wherein the first part is physically separated from the second part.

2. A laundry product according to claim 1 wherein the cleaning composition comprises a bleach activator selected from the group consisting of C4-C16 alkanoyl oxy benzene sulphonates.

3. A laundry product according to claim 2 wherein the hydrophobic bleach activator has the chemical structure:

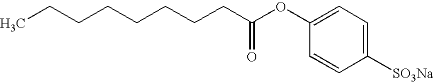

4. A laundry product according to claim 1 wherein the bleaching composition further comprises a bleach activator selected from the group consisting of C4-C16 alkanoyl oxy benzene sulphonates

5. A laundry product according to claim 4 wherein the hydrophobic bleach activator has the chemical structure:

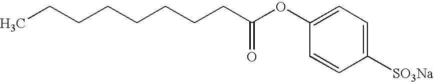

6. A laundry product according to claim 1 wherein the bleaching composition further comprises hydrogen peroxide.

7. A laundry product according to claim 1 wherein the dispensing means is a press-tap.

8. A laundry product according to claim 7 wherein the dispenser is capable of dispensing a first part to second part composition ratio of from about 10:90 to about 90:10.

9. A laundry product according to claim 6 wherein the product further comprises an effervescing system.

10. A laundry product according to claim 9 wherein the effervescing system comprises the cleaning composition further comprising a peroxide reducing enzyme or/and a base and the bleaching composition further comprising hydrogen peroxide and/or a hydrogen peroxide source and/or a suitable acid agent.

11. A laundry product according to claim 1 wherein the bleaching composition further comprises a preformed diacyl peroxide.

12. A laundry product according to claim 4 wherein a diacyl peroxide is produced inside the product by the reaction between PAP and a hydrophobic bleach activator.

13. A laundry product according to claim 4 wherein the product forms a wash bath when both parts are combined with water and wherein said wash bath comprises an asymmetric diacyl peroxide.

14. A laundry product according to claim 3 wherein the cleaning composition comprises from about 0.1% to about 10%, by weight of the cleaning composition, of the hydrophobic bleach activator and the activator is selected from the group consisting of C5-C16 hydrophobic bleach activators and mixtures thereof.

15. A laundry product according to claim 4 wherein the bleaching composition comprises from about 0.1% to about 30%, by weight of the bleaching composition of PAP.

16. A laundry product according to claim 15 wherein the bleaching composition further comprises from about 0.1% to about 10%, by weight of the bleaching composition, of a peroxide source.

17. A laundry product according to claim 1 wherein the package is a dual-compartment container, having a first and second compartment.

18. A laundry product according to claim 17 wherein the cleaning composition is contained within the first compartment and the bleaching composition is contained within the second compartment.

19. A laundry product according to claim 18 wherein the cleaning composition and the bleaching composition are dispensed simultaneously.

20. A stable aqueous laundry product provided in a first and second part comprising:
a) a first part comprising a liquid cleaning composition having a pH of from about 4 to about 10;
b) a second part comprising a bleaching composition, said bleaching composition comprising a peroxyacid;
wherein:
c) the laundry product further comprises a hydrophobic bleach activator; and
d) the first and second parts are contained within a package wherein the first part is physically separated from the second part.

21. A laundry product according to claim 19 wherein the cleaning composition is located in a first compartment and the bleaching composition is located within a second compartment and the cleaning composition and bleaching composition may be simultaneously dispensed from the container by means of a press-tap.

22. A method of forming diacyl peroxide (DAP) in-situ in the drum of a washing machine, said method comprising the steps of:
a) dispensing a laundry product comprising a first part and a second part into the drum of a washing machine and
b) partially filling the drum with water;
wherein the first part comprises a cleaning composition comprising a hydrophobic bleach activator and the second part comprises a bleaching composition comprising a peroxyacid; and
wherein the first part is physically separated from the second part until dispensed into the drum.
